(19) United States
(12) Patent Application Publication
(10) Pub. No.: US 2004/0032047 A1
(43) Pub. Date: Feb. 19, 2004

(54) Raw material composition of environmental protection coffin and manufacturing method thereof

(76) Inventors: Yu-Chuan Hou, Taipei (TW); Yu-Kuio Two, Yung Ho City (TW)

Correspondence Address: BROWDY AND NEIMARK, P.L.L.C., 624 NINTH STREET, NW, SUITE 300, WASHINGTON, DC, 20001-5303, US

(21) Appl. No.: 10/222,800

(22) Filed: Aug. 19, 2002

(51) Int. Cl. B27N 5/00

(52) U.S. Cl. 264/122; 264/129; 264/132

(57) ABSTRACT

A raw material composition of environmental protection coffin comprises a composite material, a filling material, and an adhesive. The composite material is made of powders formed by crushing an agricultural waste. The filling material is a natural amylum material, and is used to fill gaps of the composite material. The adhesive is polyvinylalcohol, and uses water as the medium for adhesion to bind the filling material and the composite material together. A manufacturing method of an environmental protection coffin comprises the steps of: raw material baking, raw material crushing, material mixing, mold pressing, drying by air, waterproof processing, assembly, and painting.

### 1. FIELD OF THE INVENTION

The present invention relates to a raw material composition of environmental protection coffin and a manufacturing method thereof and, more particularly, to an environmental protection coffin of simple operation and low cost, which is made of raw material of natural wastes, and can decompose quickly without any pollution to the environment. Moreover, it is not necessary to cut down trees to result in damage to the natural environment.

### 2. BACKGROUND OF THE INVENTION

Nowadays, along with rapid progress of science and technology, people have more and more requirements for the basic necessities of life. Science and technology brings enhancement of the quality of life, but also results in much damage to the natural environment. People gradually realize that destruction of environment will bring irreversible influence to all creatures on the Earth. Deforestation of trees badly affects soil conservation and circulation of gases on the Earth, and further results in excess of carbon dioxide in the atmosphere, hence causing global greenhouse effect. It only takes several hours to cut down a tree, but growing a tree requires several tens of years. In recent years, due to awakening of the environmental protection consciousness, people have to effectively make use of precious trees on the Earth.

Use of coffin is very important regardless of the east and west. Conventionally, a coffin is required to stow a corpse. Usually, the coffin is made of wood, hence speeding up deforestation of trees. Moreover, the wood used is finer and denser, and hence decomposes difficultly. In the Chinese tradition, when skeletons are picked up after several years of interment, it is necessary to further burn the coffin due to difficult decomposition, hence resulting in secondary pollution.

### SUMMARY OF THE INVENTION

The primary object of the present invention is to provide a raw material composition of environmental protection coffin, which comprises a composite material of a weight percentage of 25˜40%, a filling material of a weight percentage of 25˜40%, and an adhesive of a weight percentage 15˜20%. The composite material is made of powders formed by crushing an agricultural waste. The filling material is a natural amylum material, and is used to fill gaps of the composite material. The adhesive is polyvinylalcohol (PVA), and uses water as the medium for adhesion. The adhesive is used to bind the filling material and the composite material together.

The manufacturing method comprises the following steps.

(1) Raw material baking: An agricultural waste is dried up.

(2) Raw material crushing: The agricultural waste is cut into small fragments and is then crushed into fine powders.

(3) Material mixing: The agriculture waste powders are sent into a material mixing machine, and the adhesive (PVA) and the filling material (amylum material) are then added in, and they are uniformly mixed into a mixed material with water as the medium.

(4) Mold pressing: The above mixed material is guided into a mold presser for mold pressing with high temperatures and high pressures. Drawing of patterns is then performed after cooling.

(5) Drying by air: Baking and shaping are then performed.

(6) Waterproof processing: A layer of waterproof material is painted on the outer coat, and baking is then performed.

(7) Painting: The above shaped moldboard is further lacquered with color patterns to accomplish the finished product.

The various objects and advantages of the present invention will be more readily understood from the following detailed description when read in conjunction with the appended drawing, in which:

### BRIEF DESCRIPTION OF THE DRAWINGS

FIG. 1 is a manufacturing flowchart according to a first embodiment of the present invention;

FIG. 2 is a manufacturing flowchart according to a second embodiment of the present invention;

FIG. 3 is a diagram showing kinds of the composite material of the present invention;

FIG. 4 is a diagram of an environmental protection coffin according to the first embodiment of the present invention; and

FIG. 5 is a diagram of an environmental protection coffin according to the second embodiment of the present invention.

### DETAILED DESCRIPTION OF THE PREFERRED EMBODIMENTS

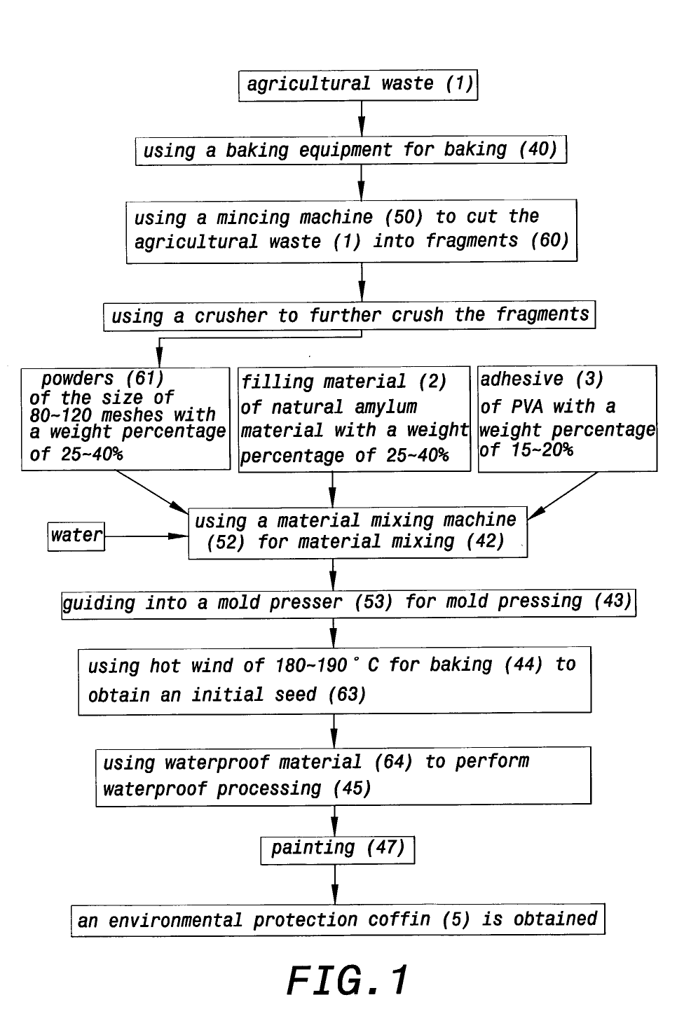

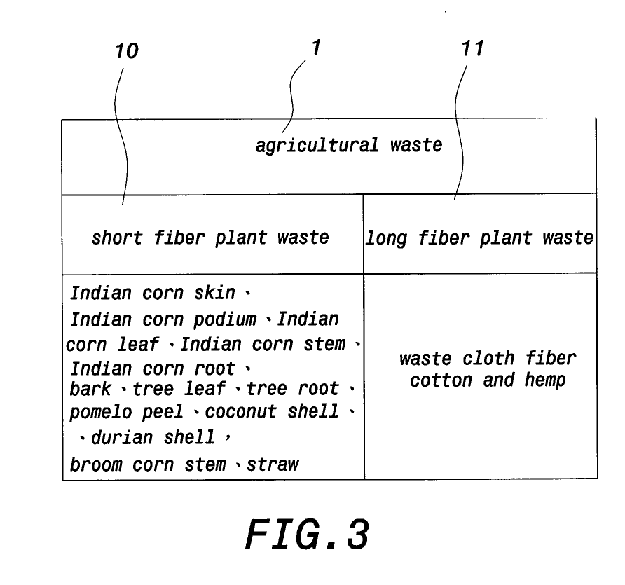

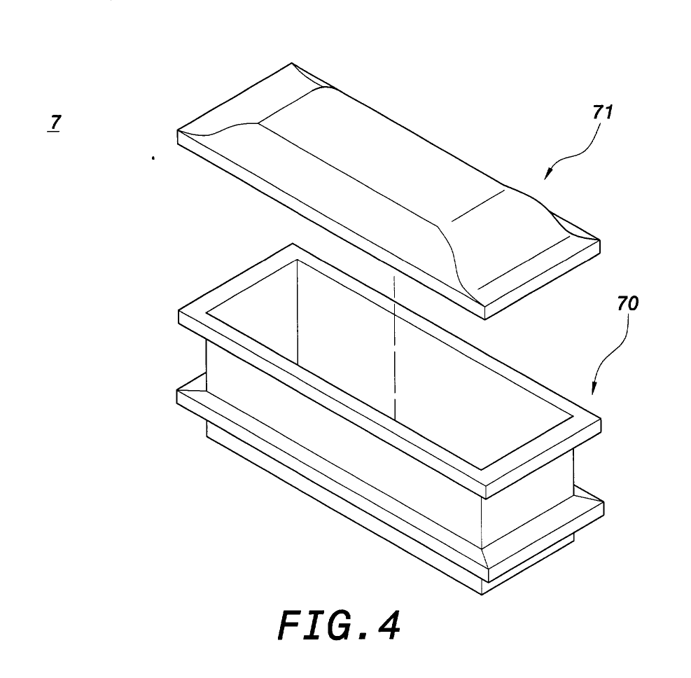

FIGS. 1, 3, and 4 show a first embodiment of the present invention. The present invention relates to a raw material composition of environmental protection coffin, which comprises an adhesive 3 of a weight percentage of 15˜20%, a filling material 2 of a weight percentage of 25˜40%, and an agricultural waste of a weight percentage of 25˜40%. The adhesive 3 belongs to unsaturated resins. In the present invention, the adhesive 3 is polyvinylalcohol (PVA), which has inflammability. The adhesive 3 can use water as the medium for adhesion. The adhesive 3 is used to bind the filling material 2 and the agricultural waste 1 together. The filling material 2 is a natural amylum material. The agricultural waste 1, the filling material 2, and the adhesive 3 are mixed with weight percentages of 25˜40%, 25˜40%, and 15˜20%, respectively. The filling material 2 can be used to fill gaps. The ingredient of the agricultural waste 1 is cellulose sodium or lignocellulose. The agricultural waste 1 is cut into units of smaller volumes, and is then further ground into powders. The size of the powders is about 80˜120 meshes. The agricultural waste 1 can be divided into two kinds. One is short fiber plant waste 10, which includes barks, tree leaves, tree roots, pomelo peels, coconut shells, durian shells, broom corn stems, straws, Indian corn skins, Indian corn podiums, Indian corn leaves, Indian corn stems, and Indian corn roots. The other is long fiber plant waste 11, which includes waste cloth fibers, cottons, and hemps.

The manufacturing method comprises the following steps.

(1) Raw material baking 40: The agricultural waste 1 is dried up by insolation or artificially.

(2) Raw material crushing 41: The agricultural waste 1 is cut into small fragments 60 with a mincing machine 50 and is then crushed into powders 61 with a crusher 51. The size of the powders 61 is about 80˜120 meshes.

(3) Material mixing 42: The powders 61 of the agriculture waste 1 are sent into a material mixing machine 52, and the adhesive 3 (unsaturated resin PVA) and the filling material 2 (natural amylum material) are then added in, and they are uniformly mixed into a mixed material 62 with water as the medium.

(4) Mold pressing 43: The above mixed material 62 is guided into a mold presser 53 for mold pressing with high temperatures (180˜190° C.) and high pressures. Drawing of patterns is then performed after cooling to obtain an initial seed 63.

(5) Drying by air 44: The above initial seed 63 is then baked and shaped with hot wind of temperature 180˜190° C.

(6) Waterproof processing 45: A layer of waterproof material 64 is painted on the outer coat of the initial seed 63, and baking is then performed.

(7) Painting 47: The above shaped moldboard is further lacquered with color patterns to accomplish the finished product.

The environmental protection coffin 7 has a main body 70 and a cover body 71. The main body 70 is integrally formed.

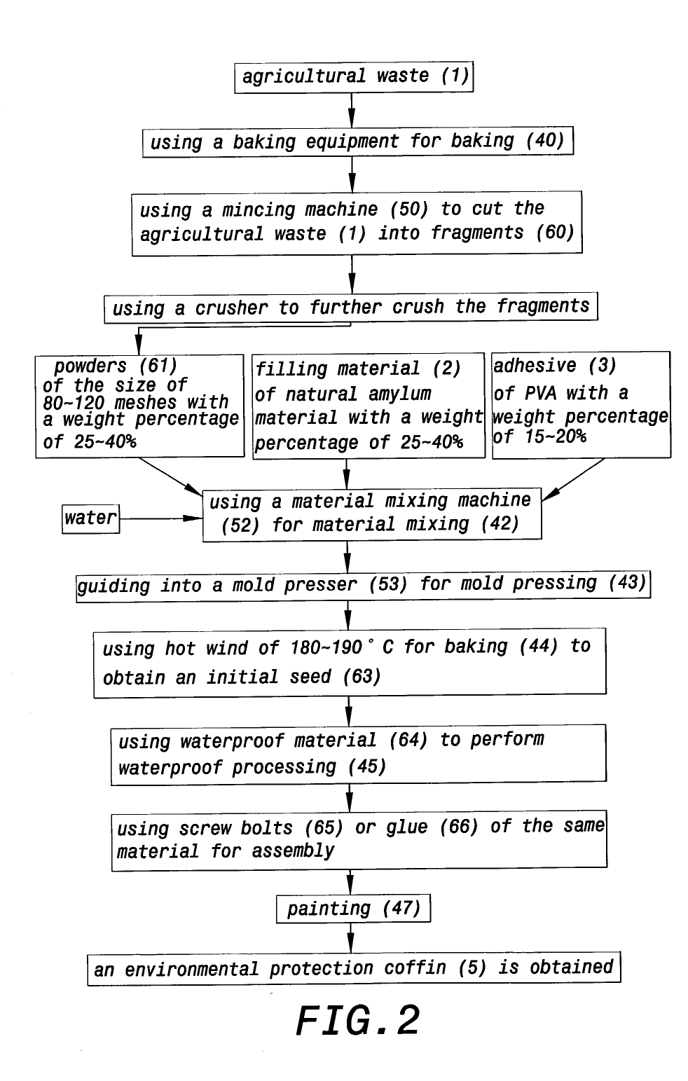

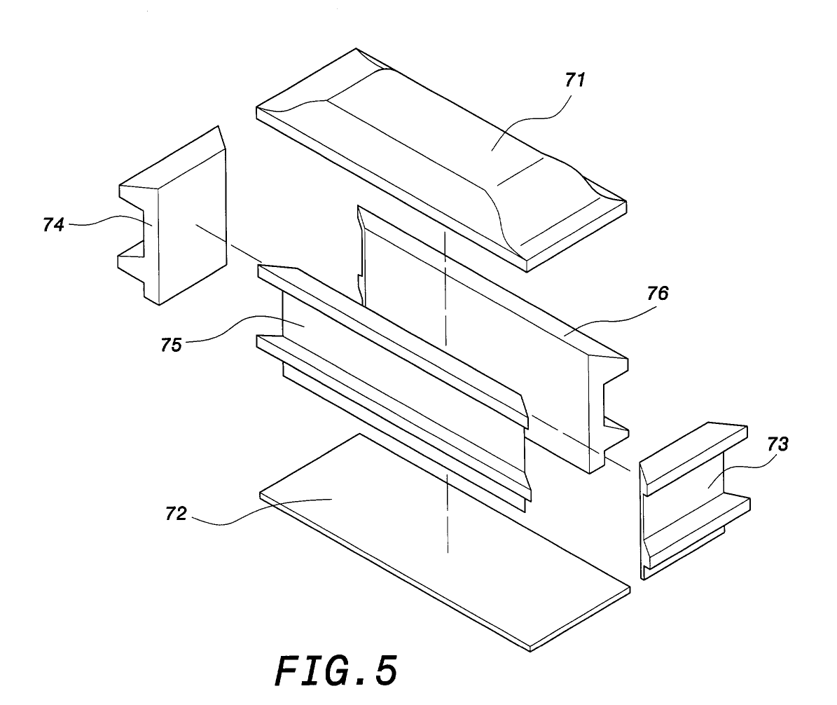

FIGS. 2 and 5 show a second embodiment of the present invention. The main body 70 of the environmental protection coffin 7 comprises a bottom seat 72, a front cover 73, a rear cover 74, a left cover 75, and a right cover 76. When manufacturing, the cover body 71, the bottom seat 72, the front cover 73, the rear cover 74, the left cover 75, and the right cover 76 are respectively mold pressed and then assembled together. When assembling, screw bolts 65 of the same material are used for assembly or glue 66 is used for binding. This step follows after Step 6 and before Step 7.

In the present invention, the acquisition of the agricultural waste is very easy. The agricultural waste has a low cost, and can decompose easily. Generally, it can dissolve or decompose after 7˜9 years of interment. The time of dissolution thereof can be by adding in silicide during manufacturing. It is not necessary to add in silicide for manufacturing environmental protection coffins for cremation. The environmental protection coffin has a mild hardness, and all the materials thereof are natural materials, which can decompose naturally without any environmental pollution. The environmental protection coffins can effectively replace conventional coffins made of wood to reduce use of wood. The raw material composition of environmental protection coffin and the manufacturing method thereof of the present invention have the following functions.

1. The present invention recycles various kinds of different wastes. The acquisition is very convenient, the cost is low, and the utmost functions of wastes are exploited.

2. The agricultural protection coffin of the present invention absolutely meets the requirement of environmental protection, and can decompose naturally without any pollution and residues.

3. The agricultural protection coffin of the present invention is nontoxic and harmless, has planking of good hardness, and will not cause environmental pollution when used.

4. After the agricultural protection coffin of the present invention is imbedded into soil, it will gradually decompose into organic fertilizer to return to the nature.

5. The present invention can solve the problem of deforestation of trees, and has an economic manufacturing cost.

6. The present invention uses a large quantity of agricultural wastes as raw materials. Therefore, recycling of wastes can be effectively accomplished, and the problem of deforestation of trees can be relieved.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

I claim:

1. A raw material composition of environmental protection coffin, comprising:
a composite material with a weight percentage of 25˜40%, said composite material being made of powders formed by crushing an agricultural waste;
a filling material with a weight percentage of 25˜40%, said filling material being a natural amylum material used to fill gaps of said composite material; and
an adhesive being polyvinylalcohol with a weight percentage of 15˜20%, said adhesive using water as a medium to bind said filling material and said composite material together.

2. The raw material composition of environmental protection coffin as claimed in claim 1, wherein said agricultural waste is a short fiber plant waste or a long fiber plant waste.

3. The raw material composition of environmental protection coffin as claimed in claim 2, wherein said short fiber plant waste includes barks, tree leaves, tree roots, pomelo peels, coconut shells, durian shells, broom corn stems, straws, Indian corn skins, Indian corn podiums, Indian corn leaves, Indian corn stems, and Indian corn roots.

4. The raw material composition of environmental protection coffin as claimed in claim 2, wherein said long fiber plant waste includes waste cloth fibers, cottons, and hemps.

5. The raw material composition of environmental protection coffin as claimed in claim 1, wherein the size of said powders is about 80˜120 meshes.

6. A manufacturing method of an environmental protection coffin, comprising the steps of:
(1) raw material baking: drying up an agricultural waste;
(2) raw material crushing: cutting said agricultural waste cut into small fragments and crushing said fragments into fine powders;
(3) material mixing: sending said powders of said agriculture waste into a material mixing machine, adding in an adhesive of polyvinylalcohol and a filling material of natural amylum material, and uniformly mixing for forming a mixed material with water as a medium;
(4) mold pressing: guiding said mixed material into a mold presser for mold pressing with high temperatures and high pressures and then performing drawing of patterns after cooling;
(5) drying by air: performing baking and shaping;
(6) waterproof processing: painting a layer of waterproof material on an outer coat of said coffin and then performing baking thereof; and
(7) painting: lacquering color patterns to accomplish said coffin.

7. The manufacturing method of environmental protection coffin as claimed in claim 6, wherein said agricultural waste is a short fiber plant waste or a long fiber plant waste.

8. The manufacturing method of environmental protection coffin as claimed in claim 7, wherein said short fiber plant waste includes barks, tree leaves, tree roots, pomelo peels, coconut shells, durian shells, broom corn stems, straws, Indian corn skins, Indian corn podiums, Indian corn leaves, Indian corn stems, and Indian corn roots.

9. The manufacturing method of environmental protection coffin as claimed in claim 7, wherein said long fiber plant waste includes waste cloth fibers, cottons, and hemps.

10. The manufacturing method of environmental protection coffin as claimed in claim 6, wherein the size of said powders is about 80˜120 meshes.

11. The manufacturing method of environmental protection coffin as claimed in claim 6, wherein said baking is performed by using hot wind of temperature 180˜190° C.

12. The manufacturing method of environmental protection coffin as claimed in claim 6, wherein said environmental protection coffin comprises a main body and a cover body.

13. The manufacturing method of environmental protection coffin as claimed in claim 12, wherein said main body is integrally formed.

14. The manufacturing method of environmental protection coffin as claimed in claim 12, wherein said main body comprises a bottom seat, a front cover, a rear cover, a left cover, and a right cover.

15. The manufacturing method of environmental protection coffin as claimed in claim 14, wherein said main body is manufactured by respectively mold pressing said bottom seat, said front cover, said rear cover, said left cover, and said right cover and then assembling.

16. The manufacturing method of environmental protection coffin as claimed in claim 15, wherein the assembly is accomplished by using screw bolts of the same material or a glue.
